(19) United States
(12) Patent Application Publication
(10) Pub. No.: US 2015/0325117 A1
(43) Pub. Date: Nov. 12, 2015

(54) Remote Controller Circuit

(71) Applicant: LOOQ SYSTEM INC., Santa Clara, CA (US)

(72) Inventor: Woody YU, Santa Clara, CA (US)

(73) Assignee: LOOQ SYSTEM INC., Santa Clara, CA (US)

(21) Appl. No.: 14/274,371

(22) Filed: May 9, 2014

(51) Int. Cl. G08C 23/04; H04B 10/116

(52) U.S. Cl. CPC G08C 23/04; H04B 10/116

(57) ABSTRACT

The present disclosure relates to the field of wireless remote control technologies, and specifically to a remoter controller circuit. The remote controller circuit comprises a printed circuit board, and at least two sets of infrared emitter tubes arranged in parallel at an end of the printed circuit board, wherein each set of said at least two sets of infrared emitter tubes comprises a plurality of infrared emitter tubes connected in parallel and/or the infrared emitter tubes of said at least two sets of infrared emitter tubes are arranged at a certain angle. The present disclosure increases a controllable scope by changing a parallel arrangement manner of infrared emitter tubes in the original circuit to an arrangement manner with a certain angle; or increases an emitting power, enlarges an infrared emitting section and achieves an effect obviously stronger than the basic circuit by changing the number of original infrared emitter tubes, thereby achieving an obvious effect with a minor modification.

### FIELD

The present disclosure relates to the field of wireless remote control technologies, and specifically to a remoter controller circuit.

### BACKGROUND

At present, as people's material and cultural life levels improve increasingly, tens of thousands of families are in possession of various household appliances, a majority of which have their respective different remote controller circuits. A remote controller circuit is a device for remotely controlling an apparatus. A modern remote controller circuit mainly consists of an integrated circuit board and keys for generating different messages. The remote controller circuit functions in a way that when a user presses a key, it converts key information to an infrared signal receivable by a television set.

Conventional infrared remote controllers chiefly comprise a decoding section and a transmission section. The decoding section converts a signal of a pressed function key into an excitation signal corresponding to the function, and the transmission section controls an infrared LED to perform according to the excitation signal to form a remote control signal. A remote control effect mainly depends on a capability of the transmission section. As shown in FIG. 1, a conventional remote controller circuit generally uses two parallel-arranged infrared LED emitter tubes to transmit the infrared signal. Usually the two LEDs operate alternatingly and they can transmit infrared signal with an about 40 KHz carrier. However, limited by a transmission capability of the LED, the current remote controllers are often confronted with the following problems: some products' control distance is too short (e.g., some products can only achieve a 3-5 m effective control distance); or signal error rates of some products are too high (e.g., it occurs often that a TV set cannot be controlled by a remote controller, and as such the remote control effect is undesirable).

### BRIEF SUMMARY

The present disclosure provides a remote controller circuit, comprising a printed circuit board, and at least two sets of infrared emitter tubes arranged in parallel at one end of the printed circuit board. Each set of the at least two sets of infrared emitter tubes comprises a plurality of infrared emitter tubes connected in parallel and/or the infrared emitter tubes of the at least two sets of infrared emitter tubes are arranged at a certain angle.

Preferably, the remote controller circuit further comprises two excitation signal input ports, wherein the excitation signal input ports are coupled to an audio output port of a hand-held terminal, and the excitation signals trigger the infrared emitter tubes to operate.

Preferably, a plurality of key contacts and electronic components of the decoding section are integrated on the printed circuit board.

Preferably, the excitation signal input port is an earphone plug, and the audio output port of the hand-held terminal is an earphone jack.

Preferably, the certain angle is less than 40 degrees.

Preferably, the two sets of infrared emitter tubes are arranged symmetrically about a central axis.

Preferably, when each set includes a plurality of infrared emitter tubes connected in parallel, the infrared emitter tubes in the set are arranged in parallel with one another.

Preferably, the sets of infrared emitter tubes operate alternatingly.

Preferably, the infrared emitter tubes are infrared LEDs.

Preferably, the infrared emitter tubes have an emitting carrier of from 30 khz to 60 khz.

### BRIEF DESCRIPTION OF DRAWINGS

FIG. 1 illustrates a circuit diagram of a remote controller circuit in the prior art.

FIG. 2 illustrates a circuit diagram of a remote controller circuit according to a first embodiment of the present disclosure.

FIG. 3 illustrates a circuit diagram of a remote controller circuit according to a second embodiment of the present disclosure.

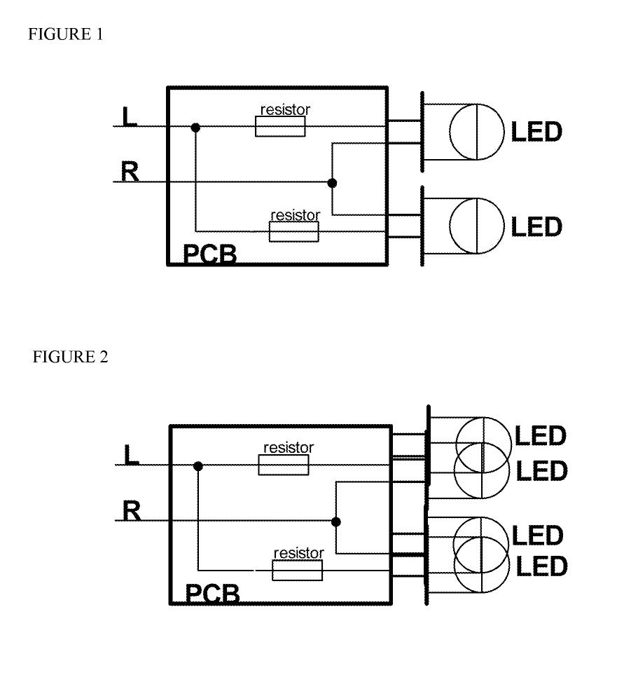

### DETAILED DESCRIPTION OF PREFERRED EMBODIMENTS

Some terms are used in the description and claims to designate specific assemblies. Those skilled in the art would appreciate that hardware manufacturers might use different terms to designate the same part. In the description and claims, parts are not distinguished by difference of names of parts, but by difference of parts in function. What are depicted subsequently in the description are preferred embodiments for implementing the present disclosure. However, the depictions aim to describe general principles of the present disclosure, not to limit the scope of the present disclosure. The scope of the present disclosure should be subjected to what are defined by the appended claims.

The present disclosure will be described in more detail with reference to figures, but the described description is not intended to limit the present disclosure.

The present disclosure provides a remote controller circuit, which increases a controllable scope by changing a parallel arrangement manner of infrared emitter tubes in the original circuit to an arrangement manner with a certain angle; or increases an emitting power, enlarges an infrared emitting section and achieves an effect obviously stronger than the basic circuit by changing the number of original infrared emitter tubes, thereby achieving an obvious effect with a minor modification.

Embodiments of the present disclosure provide a remote controller circuit, comprising a printed circuit board, and at least two sets of infrared emitter tubes arranged in parallel at one end of the printed circuit board, wherein each set of the at least two sets of infrared emitter tubes comprises a plurality of infrared emitter tubes connected in parallel and/or the infrared emitter tubes of the at least two sets of infrared emitter tubes are arranged at a certain angle.

According to one embodiment, the present disclosure enhances the remote control effect and expands a control scope of the remote controller by changing the number of the infrared emitter tubes and/or regulating the angle between the infrared emitter tubes. Preferably, the infrared emitter tube is an infrared LED which may directly convert electrical energy into near-infrared light (invisible light) and irradiate it out. The optical device is mainly applied to various photoelectrical switches and remote control emitter circuits, made of a semiconductor material such as GaAs or GaAlAs, and encapsulated by using full transparent or light blue or black resin.

Preferably, a plurality of key contacts and electronic components of the decoding section are integrated on the printed circuit board. The key contacts each obtain a trigger signal corresponding to the function key according to the user's operations. The decoding section converts the trigger signal to an excitation signal, which corresponds to the function, for the at least two sets of infrared emitter tubes. In a more preferable embodiment of the present disclosure, the above remote controller circuit is further simplified and then adapt it to a hand-held terminal (such as a mobile phone, or a flat panel computer), whereupon the hand-held terminal provides a remote control key (it may be either a physical key or a virtual key displayed in a touch screen) and decodes to produce the excitation signal. The remote controller circuit no longer contains key contacts and the decoding section, and instead only provides two excitation signal input ports which are coupled to an audio output port of the hand-held terminal. Typically, the audio signal output port of the hand-held terminal is usually an earphone jack, so the excitation signal input port is produced in the form of an earphone plug for insertion into the earphone jack of the handheld terminal to receive the excitation signal outputted by the handheld terminal. Certainly, those skilled in the art would appreciate that combination of the above two modes is also within the scope of the present disclosure.

Further referring to FIG. 2, in a first preferred embodiment of the present disclosure, the remote controller circuit comprises two sets of infrared emitter tubes arranged in parallel, wherein each set of infrared emitter tubes comprises two infrared emitter tubes connected in parallel, and the two sets of infrared emitter tubes are arranged in parallel with each other. In contrast to only two infrared emitter tubes arranged in parallel in the prior art, the infrared emitter tubes in the present embodiments are divided into two routes. Each route is provided with one additional infrared emitter tube connected in parallel to increase the total number of the emitter tubes, and finally the circuit includes a total of four emitter tubes. As such, one original emitter tube on one route becomes dual emitter tubes, thereby increasing the emitting power, enlarging the infrared ray emitting section and achieves an effect obviously stronger than the original basic circuit. Certainly, this preferred embodiment may further be modified in a way that in-parallel emitter tube is added on only one of the routes, or in a way that a plurality of in-parallel emitter tubes in a larger number are added on each route, or in a way that more routes (sets) of infrared emitter tubes are provided. This is by no means limited here.

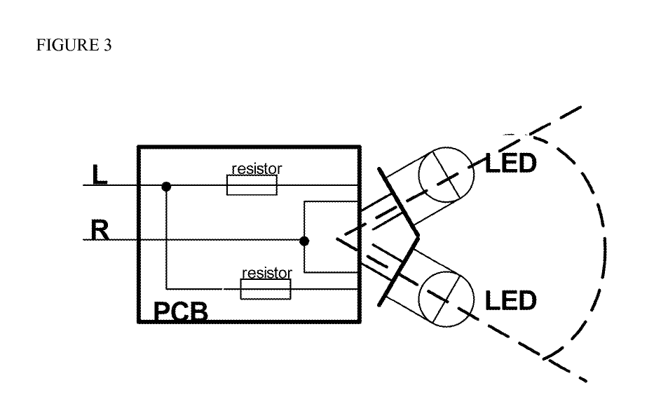

Then referring to FIG. 3 again, according to a second preferred embodiment of the present disclosure, the remote controller circuit comprises two sets of infrared emitter tubes arranged in parallel, wherein each set of infrared emitter tube includes only one infrared emitter tube, but the two sets of emitter tubes are arranged at a certain angle. In this preferred embodiment, the parallel arrangement structure of the original infrared emitter tubes is changed such that the two infrared emitter tubes are arranged at a certain angle (preferably the angle is controlled to be less than 40 degrees). As compared with the parallel arrangement in the prior art, assembling of the infrared emitter tubes at a certain angle expands a radiation area of the infrared emitter tubes, and increases a controllable scope of the remote controller so that there are signals in a range of 0 to 4 meters, and particularly an excellent remote control effect is achieved in a space range of about 3-meter remote control distance. At this time, an infrared ray receiving window may control a TV set or electronic device in a way that the remote control circuit needn't rigidly point to the TV set or other remote-controllable electronic devices. When the remote control distance exceeds 4 meters, the remote control distance and remote control effect will be affected since the signals emitted by the two infrared emitter tubes are scattered to a larger extent.

On the basis of the above preferred embodiments, more preferably, the above two preferred embodiments may be combined in a way that the two sets of infrared emitter tubes are arranged at a certain angle (or at least two sets among more sets are arranged at a certain angle), and meanwhile each set includes a plurality of in-parallel infrared emitter tubes. As such, this not only enlarges a controllable scope, but also increases the emitting power and the emitting section to make the remote control effect better.

A basic operation procedure of the remote controller in the embodiments of the present disclosure is as follows: when one key on the remote controller is pressed, a certain internal circuit of the remote controller is energized. A chip on the circuit board can detect energization of the circuit, and determines which key is pressed. According to the function of the key, the decoding section converts the key trigger signal to an excitation signal with a corresponding coded sequence, and the signal is enlarged and processed by a transistor and then sent to the LED. Controlled devices each has a corresponding infrared light-electricity converting element, e.g., an infrared receiving diode, or photoelectric triode, the LED then converts it to an invisible infrared signal, a sensor in the TV set or other electronic terminals can receive this infrared ray and detect whether the signal is already processed correctly, and then the signal can control the object.

The infrared remote control procedure of the remote controller in embodiments of the present disclosure is mainly divided into three sections: modulating, emitting and receiving. Data are transmitted in a modulated manner by the infrared remote control, and a carrier signal is added. This improves the emitting efficiency and reduces electrical power consumption. The modulated carrier generally has a frequency in a range between 30 khz and 60 khz, and in most cases, a square wave of 38 khz with a duty cycle of ⅓ is used. Currently, many chips may achieve the infrared ray transmission, and different types of encoding may be sent according to selections. An emitting system is generally powered by a battery, which requires very low power consumption of the chip. Chips are mostly designed to be in a dormancy state, and begin to work when a key is pressed. In this way, the power consumption can be reduced. A crystal oscillator used by a chip should have a sufficient capability against physical impacts. Generally a ceramic resonator is selected as the crystal oscillator. Accuracy of the ceramic resonator is not so high as that of a quartz crystal, but generally a little error may be neglected. Infrared rays are sent out by an infrared LED. Materials in the infrared LED are different from those of ordinary LEDs. When a certain voltage is applied at both ends of the infrared LED, it emits infrared rays which are not visible light. An infrared receiving circuit is usually integrated by a manufacturer into one element and becomes an integral infrared receiving head. The internal circuit comprises an infrared monitoring diode, an amplifier, an amplitude limiter, a band pass filter, an integral circuit, a comparator and so on. The infrared monitoring diode monitors an infrared signal, and then sends the signal to the amplifier and the amplitude limiter. The amplitude limiter controls a pulse amplitude at a certain level, regardless of a distance of the infrared emitter and the receiver. An AC signal enters the band pass filter through which a negative carrier of from 30 khz to 60 khz may pass. The carrier enters the comparator through a demodulating circuit and the integral circuit. The comparator outputs high and low levels, and a signal waveform is reshaped at an emitter end. The outputted high and low levels are in antiphase with the emitter end, only to improve receiving sensitivity.

As compared with the prior art, the present disclosure provides a remote controller circuit, which increases the controllable scope by changing the parallel arrangement manner of two infrared emitter tubes in the original circuit to an arrangement manner with a certain angle; or increases the emitting power, enlarging the infrared emitting section and achieves an effect obviously stronger than the basic circuit by increasing the number of infrared emitter tubes in the original circuit.

The above description illustrates and depicts several preferred embodiments. As stated above, it should be appreciated that the present disclosure is not limited to the forms disclosed in the text, and should not be considered as excluding other embodiments. The present disclosure may be used for various other combinations, modifications and environments, and can be modified through the above teaching or technologies or knowledge in the relevant fields within the scope of inventive contribution of the disclosure. Any modifications and variations made by those skilled in the art all should be regarded as falling within the scope defined by the appended claims of the present disclosure so long as they do not depart from the spirit and scope of the present disclosure.

1. A remote controller circuit, comprising:
a printed circuit board, and
at least two sets of infrared emitter tubes arranged in parallel at one end of the printed circuit board,
each set of the at least two sets of infrared emitter tubes comprising a plurality of infrared emitter tubes connected in parallel and/or the infrared emitter tubes of the at least two sets of infrared emitter tubes are arranged at a certain angle.

2. The remote controller circuit according to claim 1, further comprising two excitation signal input ports, wherein the excitation signal input ports are coupled to an audio output port of a hand-held terminal, and the excitation signals trigger the infrared emitter tubes to operate.

3. The remote controller circuit according to claim 1, further comprising a plurality of key contacts integrated on the printed circuit board.

4. The remote controller circuit according to claim 2, further comprising a plurality of key contacts integrated on the printed circuit board.

5. The remote controller circuit according to claim 1, further comprising electronic components of a decoding section integrated on the printed circuit board.

6. The remote controller circuit according to claim 2, further comprising electronic components of a decoding section integrated on the printed circuit board.

7. The remote controller circuit according to claim 2, characterized in that, the excitation signal input port is an earphone plug, and the audio output port of the hand-held terminal is an earphone jack.

8. The remote controller circuit according to claim 1, wherein the certain angle is less than 40 degrees.

9. The remote controller circuit according to claim 1, wherein the two sets of infrared emitter tubes are arranged symmetrically about a central axis.

10. The remote controller circuit according to claim 8, wherein the two sets of infrared emitter tubes are arranged symmetrically about a central axis.

11. The remote controller circuit according to claim 1, wherein, when each set includes a plurality of infrared emitter tubes connected in parallel, the infrared emitter tubes in the set are arranged in parallel with one another.

12. The remote controller circuit according to claim 1, wherein the sets of infrared emitter tubes operate alternatingly.

13. The remote controller circuit according to claim 1, wherein the infrared emitter tubes are infrared LEDs.

14. The remote controller circuit according to claim 1, wherein the infrared emitter tubes have an emitting carrier of from 30 khz to 60 khz.
